(19) United States
(12) Patent Application Publication
(10) Pub. No.: US 2012/0132827 A1
(43) Pub. Date: May 31, 2012

(54) ION ACCELERATION METHOD, ION ACCELERATION APPARATUS, ION BEAM IRRADIATION APPARATUS, AND ION BEAM IRRADIATION APPARATUS FOR MEDICAL USE

(75) Inventors: Yuji Fukuda, Kyoto (JP); Tatsufumi Nakamura, Kyoto (JP)

(73) Assignee: JAPAN ATOMIC ENERGY AGENCY, Ibaraki (JP)

(21) Appl. No.: 13/292,871

(22) Filed: Nov. 9, 2011

(30) Foreign Application Priority Data
Nov. 29, 2010 (JP) 2010-264833

(51) Int. Cl. H01J 27/24

(52) U.S. Cl. 250/423 P

(57) ABSTRACT

A laser light is emitted from a laser light source and focused inside a cluster-gas. A nozzle is installed in a vacuum. The nozzle is configured so that a jet of gas can be jetted from its top into the vacuum. The gas is a mixed gas of helium and carbon dioxide. The gas jetted into the vacuum undergoes adiabatic expansion with a steep cooling, which produces the cluster-gas. In the cluster gas, a large number of CO₂ molecules aggregate into nanosized CO₂ clusters which suspend in the gas of He atoms. It is preferred that the light focal point be located in a rear part of the cluster-gas. The most preferred are 80% to 100% positions of the orifice as seen from the front side.

### FIELD OF THE INVENTION

The present invention relates to an ion acceleration method and an ion acceleration apparatus for accelerating a desired ion to high energy for output. The present invention also relates to the structures of an ion beam irradiation apparatus and an ion beam irradiation apparatus for medical use using the same.

### DESCRIPTION OF THE RELATED ART

Various types of technologies have been known that irradiate a sample with an ion beam consisting of accelerated ions (including protons) for machining, film deposition, analysis, medical practice, etc. Such technologies need a high-energy, high-intensity ion beam stably generated. An apparatus that generates a high-energy ion beam for irradiation typically needs a lot of equipment for the mechanism of accelerating ions to high energy in particular, which makes the entire apparatus large in size. Despite their obvious effectiveness particularly in medical applications and the like, such ion beam irradiation apparatuses are far from being widespread enough.

Under the circumstances, ion beam irradiation apparatuses capable of miniaturization have been known, among which is one using a laser-driven acceleration mechanism. For example, as described in Patent Documents 1 and 2, a laser-driven ion beam irradiation apparatus irradiates a target that can produce a lot of protons or desired ions by high-intensity ultrashort pulsed laser light, thereby vaporizing the target into a plasma. In the plasma, electrons having light mass are initially accelerated to high energy. The accelerated electrons create an electric field, which in turn accelerates heavier protons or ions. The protons or ions form a high-energy beam to irradiate the sample. An electric field for the acceleration in a conventional accelerator has a low upper limit due to restrictions such as the breakdown voltage of material. In contrast, the electric field for the acceleration in the plasma is several orders of magnitude higher and is thus capable of acceleration to high energy in a short distance. As compared to large-sized accelerators and the like that have heretofore been used, the laser-driven ion beam irradiation apparatus can be significantly reduced in overall size. Applications to medical use and various other fields have thus been expected.

For example, in medical applications, an affected area lying in a certain position and a certain depth needs to be exclusively and intensively irradiated with high-energy ions. For that purpose, it is needed to obtain a monochromatic (delta-functioned energy spectrum) high-energy ion beam with high directivity. Efforts are being made to improve the characteristics of a laser-driven ion beam irradiation apparatus so as to reach or exceed those of conventional large-sized accelerators.

Non-Patent Document 1 describes an effective technology which uses a cluster-gas, not an ordinary gas or solid, as the target that serves as a plasma source when irradiated with laser. A cluster-gas is a gas in which particulate aggregates, or clusters, of atoms or molecules suspend. A cluster-gas has properties intermediate between an ordinary gas and solid. The cluster-gas used in Non-Patent Document 1 contains CO₂ clusters suspending in He gas. It is shown that high-energy helium (He), carbon (C), and oxygen (O) ions are obtained. The cluster-gas is formed by issuing a jet of the mixed gas from a nozzle into a vacuum for adiabatic expansion.

Such an ion acceleration apparatus (ion beam irradiation apparatus) can provide a high-intensity ion beam with high directivity.

### CITATION LIST

### Non-Patent Document

[Non-Patent Document 1] Y. Fukuda, A. Ya. Faenov, M. Tampo, T. A. Pikuz, T. Nakamura, M. Kando, Y. Hayashi, A. Yogo, H. Sakaki, T. Kameshuma, A. S. Pirozhkov, K. Ogura, M. Mori, T. Zh. Esirkepov, J. Koga, A. S. Boldarev, V. A. Gasilov, A. I. Magunov, T. Yamauchi, R. Kodama, P. R. Bolton, Y. Kato, T. Tajima, H. Daido, and S. V. Bulanov, “Energy Increase in Multi-MeV Ion Acceleration in the Interaction of a Short Pulse Laser with a Cluster-Gas Target,” Physical Review Letters, Vol. 103, p. 165002 (2009)

### Patent Document

[Patent Document 1] Jpn. Pat. Appln. Laid-Open Publication No. 2006-244863
[Patent Document 2] Jpn. Pat. Appln. Laid-Open Publication No. 2008-198566

Unlike ordinary gases and solids, a cluster-gas is formed in a temporally and spatially limited region. It has thus been difficult to stably obtain a high-energy ion beam by using a cluster-gas target.

In other words, it has been difficult to provide a high-energy ion beam with high directivity by using a laser-driven acceleration mechanism.

### SUMMARY OF THE INVENTION

The present invention has been achieved in view of such a problem, and it is an object thereof to provide an invention that solves the foregoing problem.

To solve the foregoing problem, the present invention provides the following configurations.

An ion acceleration method according to the present invention is an ion acceleration method that includes irradiating a cluster-gas with pulsed laser light in a direction generally perpendicular to a jetting direction of a mixed gas to generate a plasma of the cluster-gas so that an atom constituting the cluster-gas is ionized and accelerated, the cluster-gas being formed by jetting the mixed gas including a first component gas and a second component gas from a nozzle into a vacuum to form from the nozzle a columnar shaped cluster-gas in which clusters of molecules of the second component gas suspend in the first component gas. The clusters in the cluster-gas have a density in the range of 2.0×10⁸ to 2.0×10¹⁰ cm⁻³. The pulsed laser light is focused on a position of 80% to 100% rearward of the columnar shaped cluster-gas when seen from an irradiation side.

In the ion acceleration method according to the present invention, the columnar shaped cluster-gas has a transmittance in the range of 5% to 10% to the pulsed laser light.

In the ion acceleration method according to the present invention, a duration of jetting of the mixed gas is 0.01 to 10 ms. The columnar shaped cluster-gas is irradiated with the pulsed laser light in the range of 10% to 20% the duration of jetting since generation of the cluster-gas in terms of generation timing of the cluster-gas that is formed in response to the duration of jetting.

In the ion acceleration method according to the present invention, the first component gas is He, and the second component gas is CO₂.

An ion acceleration apparatus according to the present invention is an ion acceleration apparatus for irradiating a cluster-gas with pulsed laser light to generate a plasma of the cluster-gas so that an atom constituting the cluster-gas is ionized and accelerated, the ion acceleration apparatus comprising: a nozzle that jets a mixed gas of a first component gas and a second component gas into a vacuum to form a columnar shaped cluster-gas in which clusters of molecules of the second component gas suspend in the first component gas; a laser light source that emits the pulsed laser light; and a focusing optical system that irradiates the cluster-gas with the pulsed laser light so that the pulsed laser light is focused on a preset focal point. The clusters in the cluster-gas have a density in the range of 2.0×10⁸ to 2.0×10¹⁰ cm⁻³. The focal point is located in a position of 80% to 100% rearward of the columnar shaped cluster-gas when seen from an irradiation side.

In the ion acceleration apparatus according to the present invention, the columnar shaped cluster-gas has a transmittance in the range of 5% to 10% to the pulsed laser light.

In the ion acceleration apparatus according to the present invention, a duration of jetting of the mixed gas is 0.01 to 10 ms. The columnar shaped cluster-gas is irradiated with the pulsed laser light in the range of 10% to 20% the duration of jetting since generation of the cluster-gas in terms of generation timing of the cluster-gas that is formed in response to the duration of jetting.

In the ion acceleration apparatus according to the present invention, the first component gas is He, and the second component gas is CO₂.

An ion beam irradiation apparatus according to the present invention includes a configuration that irradiates a sample with an ion accelerated by the ion acceleration apparatus.

An ion beam irradiation apparatus for medical use according to the present invention includes a configuration that irradiates an affected area with an ion accelerated by the ion acceleration apparatus.

With such configurations, the present invention can provide a high-energy ion beam with high directivity by using a laser-driven acceleration mechanism.

### BRIEF DESCRIPTION OF THE DRAWINGS

FIG. 1 is a diagram showing an outline of the configuration of an ion acceleration apparatus according to an embodiment of the present invention;

FIG. 2 is a diagram showing an timing chart for ON/OFF control on a nozzle, the amount of generation of a cluster-gas, and the output timing of pulsed laser light in the ion acceleration apparatus according to the embodiment of the present invention;

FIG. 3 shows results of shadow graph measurements by irradiating a cluster-gas with probe light, showing the distribution of a jet of gas issued from a nozzle when using a mixed gas (cluster-gas) and when using pure He gas;

FIG. 4 shows a result of optical observation of bubble structures under laser light irradiation with the cluster-gas without probe light;

FIG. 5 shows measured results of the probability of occurrence of bubble structures, the probability of occurrence of high-energy electrons, and the dependence of X-ray intensity on the position of a light focal point;

FIG. 6A shows simulation results of the electron density distribution, FIG. 6B shows the magnetic field intensity distribution, FIG. 6C shows the electric field intensity distribution in the direction of an optical axis, and FIG. 6D shows the accelerated energy distribution of electrons and ions in the cluster-gas that is irradiated with the laser light. The white line in FIG. 6A indicates an initial electron density distribution before laser irradiation; and

FIG. 7 shows a simulation result on the relationship between laser light transmittance and ion energy.

### DETAILED DESCRIPTION OF THE PREFERRED EMBODIMENTS

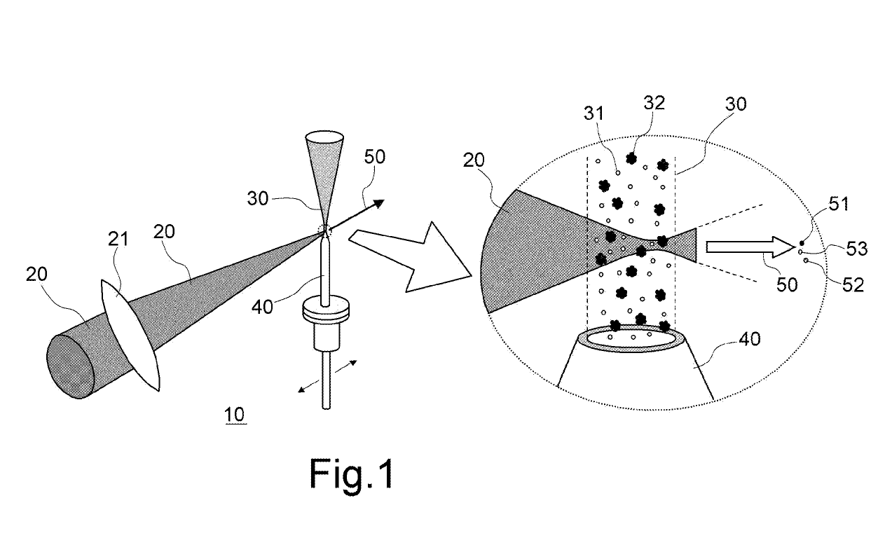

An ion acceleration apparatus according to an embodiment of the present invention will be described below. FIG. 1 is a diagram showing the configuration of the ion acceleration apparatus 10. The left part of FIG. 1 is a schematic diagram showing the overall configuration. The right part of FIG. 1 is an enlarged view of a portion of the apparatus (the portion circled in a dotted line). The configuration is the same as that described in Non-Patent Document 1.

Laser light (pulsed laser light) 20 is emitted from a laser light source and focused inside a cluster-gas (target) 30. The laser light source may be one for emitting ultrashort pulsed laser light of high intensity that can generate a plasma of the cluster-gas 30 when focused by a focusing optical system 21. The same holds for the configurations described in Patent Documents 1 and 2 and Non-Patent Document 1. Specifically, a glass laser, titanium-sapphire laser, or the like may be used as the laser light source. The focusing optical system 21 may include an aspheric focusing mirror such as an off-axis parabolic mirror. The position of the focal point to be set by the focusing optical system 21 will be described later. The laser light 20 is emitted in a pulse form at a short interval. The irradiation (oscillation) timing is controlled in synchronization with the generation of the cluster-gas 30.

A nozzle 40 is installed in a vacuum. The nozzle 40 is configured so that a jet of gas can be jetted from its top into the vacuum. The gas is a mixed gas of helium (first component gas: He) and carbon dioxide (second component gas: CO₂). The gas jetted into the vacuum undergoes adiabatic expansion with a steep cooling, which solidifies CO₂. Therefore, a columnar shaped cluster-gas 30 in which CO₂ clusters are dispersed in He gas is generated. The space for the gas to be jetted into is evacuated by a vacuum pump (not shown) so that the degree of vacuum, even with the jetting of the gas, is maintained to allow stable generation of the cluster gas. The same holds for Non-Patent Document 1. The gas is not continuously jetted but in a pulsed fashion. The timing of jetting and the irradiation timing of the laser light 20 are therefore controlled in synchronization with each other. As shown to the right in FIG. 1, the direction of jetting of the mixed gas is generally perpendicular to the direction of incidence of the laser light 20. The nozzle 40 is configured to be movable in the direction of the optical axis of the laser light 20 so that the focal point of the laser light 20 in the cluster-gas 30 can be controlled in position.

As shown to the right in FIG. 1, in the cluster-gas 30, a large number of CO₂ molecules aggregate into nanosized CO₂ clusters 32 which suspend in the gas of He atoms 31. At locations remote from the nozzle 40, He atoms 31 and CO₂ clusters 32 disperse into low density due to thermal motion. The laser light 20, and its high-intensity portion in particular, is therefore focused inside the cluster-gas 30 near the orifice of the nozzle 40.

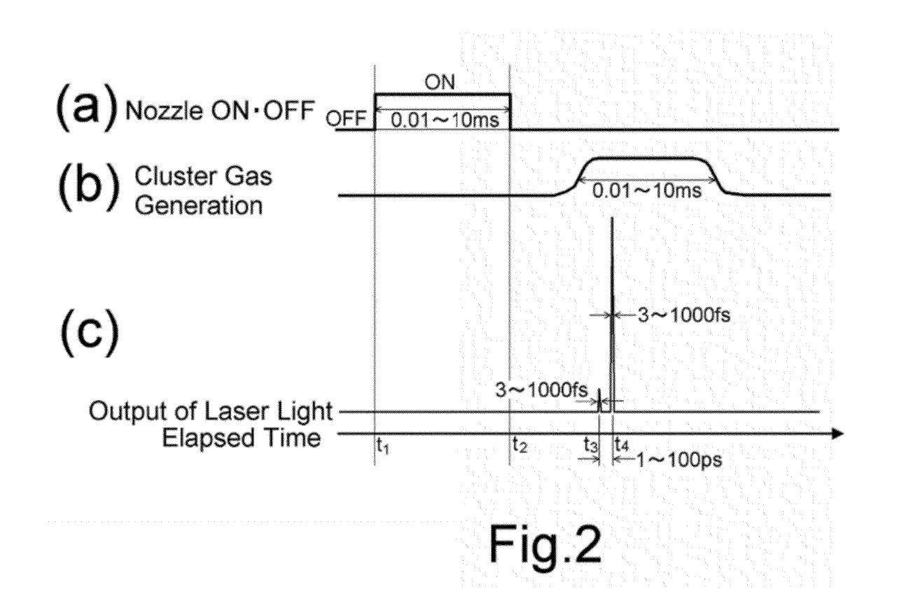

FIG. 2 shows charts of (a) the open (ON) and close (OFF) timing of the nozzle 40, (b) the amount of generation of the cluster-gas 30 at the light focal point, and (c) the output timing of the laser light 20.

The generation [(b) of FIG. 2] of the cluster-gas 30 at the light focal point is delayed from [(a) of FIG. 2] the open and close timing of the nozzle 40 as much as time needed for the gas to flow from the nozzle 40 to the light focal point. The delay time is determined by the distance from the nozzle 40 to the light focal point and the speed of the gas flow. The greater the distance, the longer the delay time.

The nozzle 40 is typically turned ON for a duration of approximately 0.01 to 10 ms. The ON and OFF are controlled by an external signal. The cluster-gas 30 is controlled ON so as to be in synchronization with [(c) of FIG. 2] the output of the laser light 20. In fact, the ON and OFF of the nozzle 40 (time t1 and

t2) and the output of the laser light 20 (time t3 and t4) are synchronously controlled with consideration given to the foregoing delay time. As described in Non-Patent Document 1, the output of the laser light 20 includes a main pulse which has high intensity and a pre-pulse which has lower intensity than the main pulse and precedes the main pulse. A difference in time between the pre-pulse and the main pulse (difference in time between t4 and t3) is set to approximately 1 to 1000 ps (for example, approximately 150 ps). Both the pre-pulse and the main pulse have a half-width of approximately 3 to 1000 fs (for example, 40 fs). The durations on the timing of the laser light 20 are negligible as compared to the ON duration of the nozzle 40.

As described in Non-Patent Document 1, such a configuration can decompose both He atoms 31 and CO₂ clusters 32 in the cluster-gas 30 into a plasma to generate and accelerate electrons. The accelerated electrons create an electromagnetic field structure in the plasma, thereby forming an electric field of high intensity for ion acceleration. As shown in FIG. 1, the electric field generates an ion beam 50 which includes high-energy carbon (C) ions 51, oxygen (O) ions 52, and helium (He) ions 53 generated in the plasma.

The inventor has experimentally analyzed the situation where the cluster-gas 30 is irradiated with the laser light 20, and found that the position of the light focal point in particular can be optimized to increase the energy of the output ions. In the cluster-gas 30, the state of plasma formation, the state of electron acceleration, and the state of ion acceleration inside vary as the position of the light focal point changes in the traveling direction of the laser light 20. Consequently, the energy distribution of accelerated ions varies depending on the position of the light focal point.

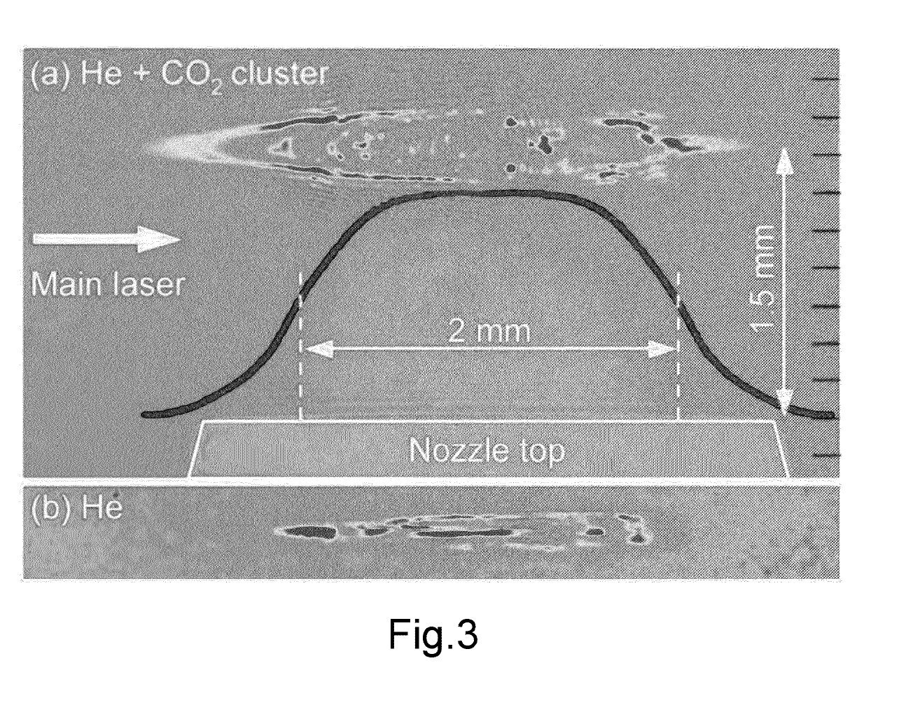

FIG. 3 shows results of measurements by a shadow graph method. The upper part of FIG. 3 shows a two-dimensional distribution of the cluster gas 30 when a jet of mixed gas containing 90% of He and 10% of CO₂ was jetted from the nozzle 40 having a 2-mm-diameter orifice under a pressure of 60 bar. The center part of FIG. 3 shows an electron density distribution in the traveling direction of the laser light 20. Here, the cluster-gas 30 was irradiated with probe light and observed from a side opposite from the irradiation. The lower part of FIG. 3 shows a two-dimensional distribution of a jet of non-mixed gas containing 100% of He. As shown in the upper and center parts of FIG. 3, the foregoing mixed gas can be used to produce the cluster-gas 30 slightly wider than the orifice (2 mm) of the nozzle 40. The half-width of the distribution corresponds to the orifice (2 mm).

Assuming that D is the density (cm⁻³) of CO₂ clusters in the cluster gas 30, and r is the radius (cm) of the CO₂ clusters, the relationship between the CO₂ cluster density D and the CO₂ cluster radius r is given by the following equation:

r=(3ρ/4πDS)^{1/3}, (1)

where ρ is the density (cm⁻³) of CO₂ molecules in the cluster-gas 30, and S is the CO₂ density (cm⁻³) in solid CO₂.

The values of ρ and S are discussed in Non-Patent Document 1 and A. S. Boldarev, V. A. Gasilov, A. Ya. Faenov, Y. Fukuda, and K. Yamakawa, “Gas-Cluster Targets for FemtosecondLaser Interaction: Modeling and Optimization,” Review of Scientific Instruments, Vol. 77, p. 083112 (2006). For example, with a 60-atm mixed gas (90% of He, 10% of CO₂), ρ=1.8×10¹⁸ cm⁻³ and S=2.1×10²² cm⁻³. From equation (1), r=(2×10⁻⁵/D)^{1/3}.

In Non-Patent Document 1, the ion beam generated is subjected to a solid state nuclear track detector (CR-39) for two-dimensional imaging and evaluation of the ion track. The energy distribution of accelerated ions depends on the position of the light focal point. Since it is difficult by using CR-39 to precisely evaluate an optimum position for the generation of high-energy ions, measurements to be described below were examined to determine a condition that can increase ion energy with higher efficiency. Here, a cluster-gas 30 of D=3.0×10⁹ cm⁻³ (r=0.2 μm) was irradiated with the laser light 20, and the emitted X-rays were measured for intensity while changing the light focal point in the direction of the optical axis of the laser light 20. The X-rays measured had energy of 665.7 eV and 653.7 eV, which correspond to the helium-beta (He_{β}) line of a hexavalent oxygen ion (O⁶⁺) and the Lyman-alpha (Ly_{α}) line of a heptavalent oxygen ion (O⁷⁺), respectively. The intensity ratio between the X-ray line emissions corresponds to the density of plasma generated. Note that such X-rays are characteristic X-rays generated by random collision excitation of high-energy electrons, with no directivity in the generation of X-rays. The X-rays detected here derived from the entire cluster-gas 30.

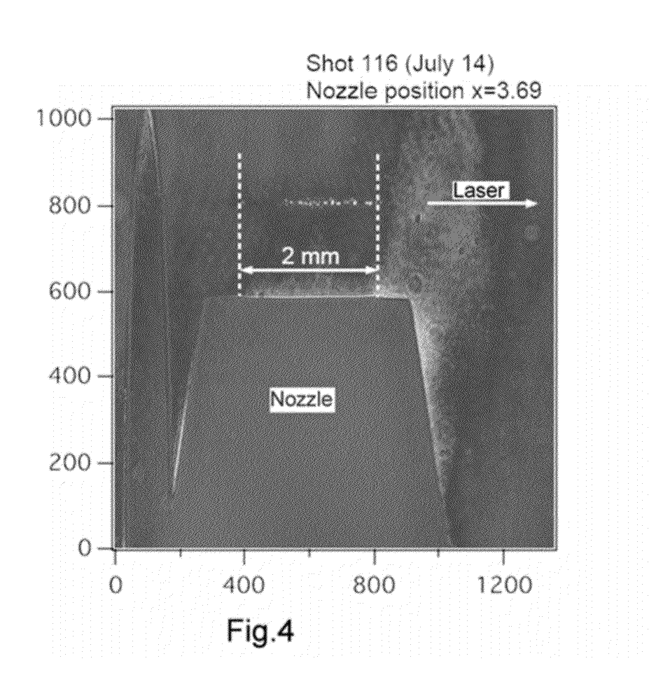

The probability of emission of high-energy electrons (electrons having energy of 5 MeV and higher) on each single irradiation of the laser light 20 was also determined. The cluster-gas 30 was also optically observed for fine structures without the irradiation of probe light. The result of the optical observation showed the occurrence of pores (bubbles). The probability of occurrence of bubbles was also measured. FIG. 4 shows an example of bubbles observed. The region between the two broken lines (2 mm in width) corresponds to the orifice of the nozzle 40. It is clear that more bubbles occur in the rear half of the cluster gas 30.

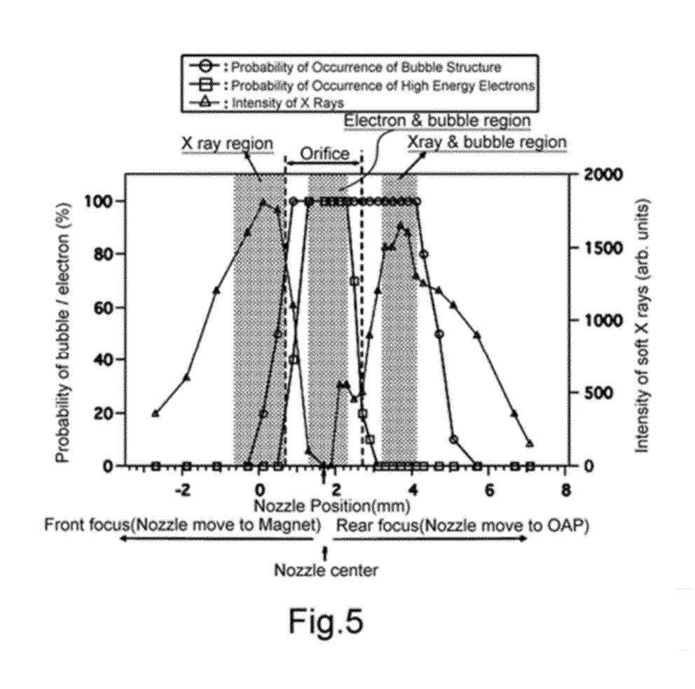

FIG. 5 shows the measured results. As in FIG. 4, the two broken lines indicate the orifice of the nozzle 40. The intensity of the X-rays peaks when the light focal point is off the cluster gas 30 (at positions of 35% in front of the orifice and 50% behind). The reason is that the laser light 20 has intensity sufficient to generate a plasma even in locations off the light focal point (the point where the light intensity maximizes), and that the cross-sections of collision excitations for generating X-rays becomes maximum. The intensity of the X-rays and the probability of emission of high-energy electrons of 5 MeV and higher have negative correlation. The reason is that the energy of electrons generated becomes so high that the cross-sections of collision excitations for generating X-rays decreases significantly if the laser light 20 is focused on the center area of the cluster gas 30.

High-energy electrons occur with particularly high probabilities in 30% to 80% positions of the orifice from the front side. The probability is near zero at locations off the orifice. Note that the probability distribution is not symmetrical with respect to the center of the orifice, but slightly shifted to the rear.

No bubble structure is observed on the front side of a 10% position of the orifice when seen from the front side. On the other hand, bubble structures are observed even at a location of 100% or so behind the 100% position of the orifice.

With the foregoing configuration, electrons which have light mass are initially accelerated into high-energy electrons. This creates an electromagnetic field structure in the plasma to produce a high electric field (sharp changes in potential). Ions, heavier than electrons, are then accelerated into high-energy ions by the electric field. Bubble structures accommodate a high electric field with no ion-scatterer. If a lot of bubble structures are formed near the end of the region where high-energy electrons are generated, such a location is particularly advantageous for the stable generation of high-energy ions. It is also evident that there occurs a plasma which generates ions to be accelerated.

In view of the foregoing, it can be clearly seen the light focal point is preferably located in the rear part of the cluster gas 30. In particular, the result of FIG. 4 shows that 80% to 100% positions of the orifice as seen from the front side are the most preferred, where the generation of high-energy electrons is past its peak, there are formed bubble structures, and there are generated X-rays.

The occurrence of a high accelerating electric field in the direction of irradiation of the laser light 20 also means improved ion directivity. In other words, setting the light focal point to the foregoing position can also provide high directivity.

If the light focal point is set to a 95% position in range, the cluster gas 30 showed a transmittance of 7% to the laser light 20. The transmittance is equivalent to the proportion of the laser light 20 simply transmitted through the cluster gas 30 without being absorbed. Part of the absorbed energy changes into ion energy. Low absorptance (high transmittance) is thus unfavorable because it lowers the energy of electrons and ions.

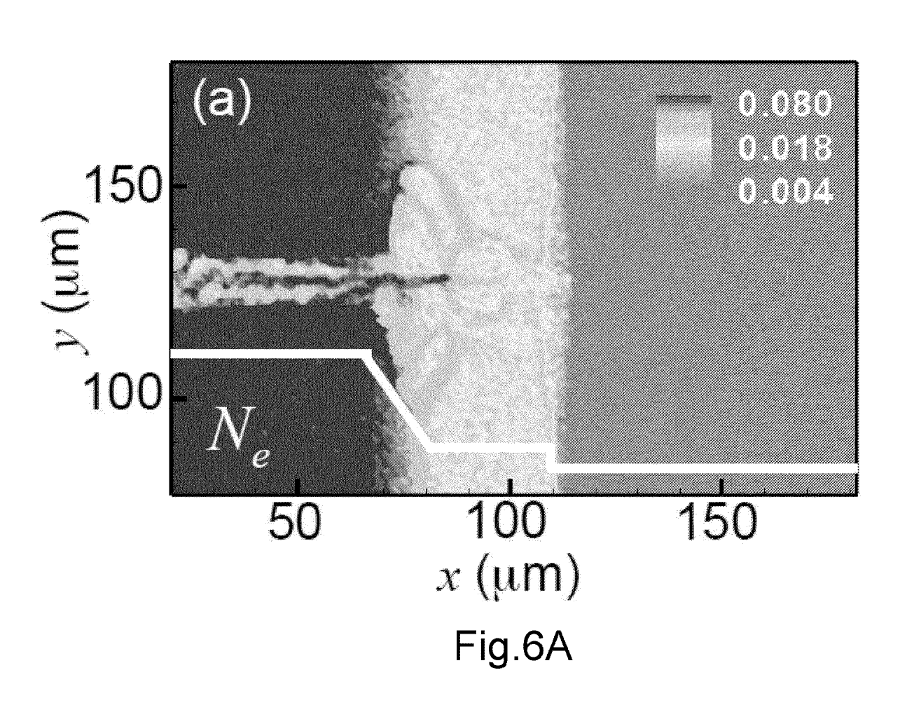

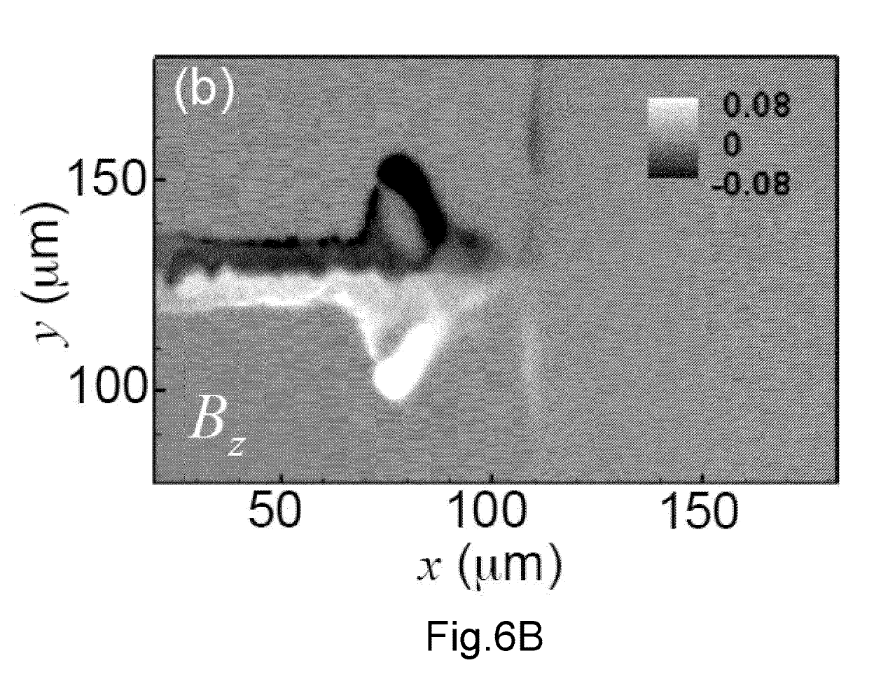

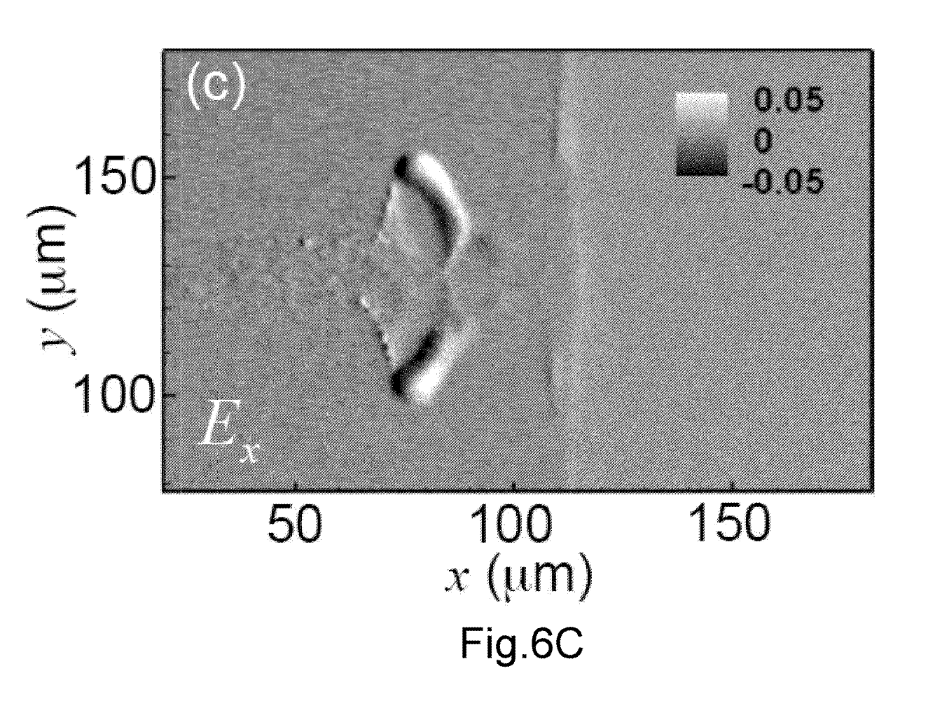

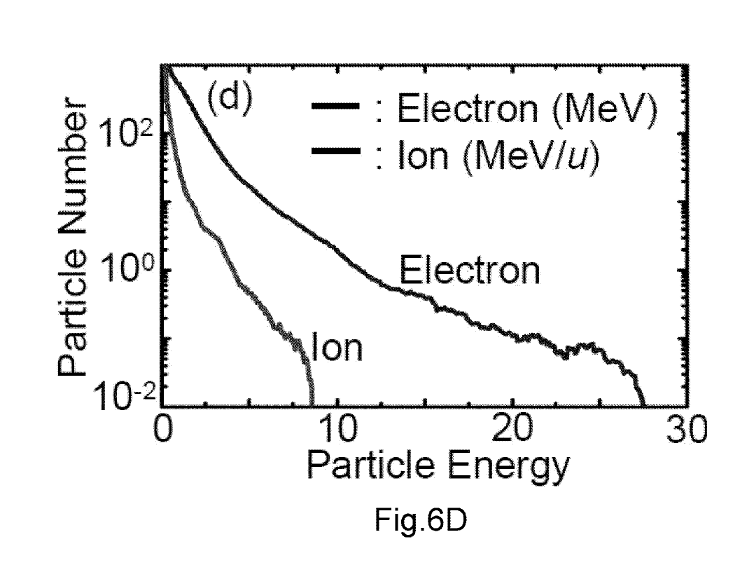

FIG. 6A shows simulation results discussed in Non-Patent Document 1, showing the electron density distribution, FIG. 6B shows the magnetic field intensity distribution, FIG. 6C shows the electric field intensity distribution in the direction of the optical axis, and FIG. 6D shows the accelerated energy distribution of electrons and ions in the cluster gas 30 that is irradiated with the laser light 20. The white line in FIG. 6A shows an initial electron density distribution before laser irradiation. In FIGS. 6A to 6C, the horizontal axis is the direction of the optical axis of the laser light 20 (rightward irradiation). The magnetic field (FIG. 6B) is generated in a vortex shape about the direction of the optical axis. The magnetic field disappears to generate an electric field, which is the accelerating electric field. The generation of the accelerating electric field is reflected on the high-intensity electric field in the range of 70<x<90 μm in FIG. 6C. In other words, the occurrence of the magnetic vortex plays a significant role in ion acceleration. The magnetic vortex is caused by the electron distribution (FIG. 6A). In particular, the magnetic vortex occurs in a region where the electron density decreases gradually (in a location of 65 to 82 μm in (FIG. 6A)). From FIGS. 6B and 6C, it can be seen that an axial accelerating electric field of extremely high intensity is formed near the point where the magnetic vortex occurs.

For efficient ion acceleration, it is important to adjust the position where the magnetic vortex is formed. The light focal point needs to be set so that the magnetic vortex occurs in such a position with respect to a given electron density distribution. Simulations showed that it is effective in view of ion acceleration to locate the magnetic vortex to a position approximately 95% from the irradiation side of the laser light 20. Shifting the position to the front decreases the transmittance of the cluster gas 30 to the laser light 20. Shifting the position to the rear increases the transmittance. The foregoing position of approximately 95% provides a transmittance of 5% to 10%. Such a relationship between the location of the magnetic vortex and the transmittance holds independent of the gas type.

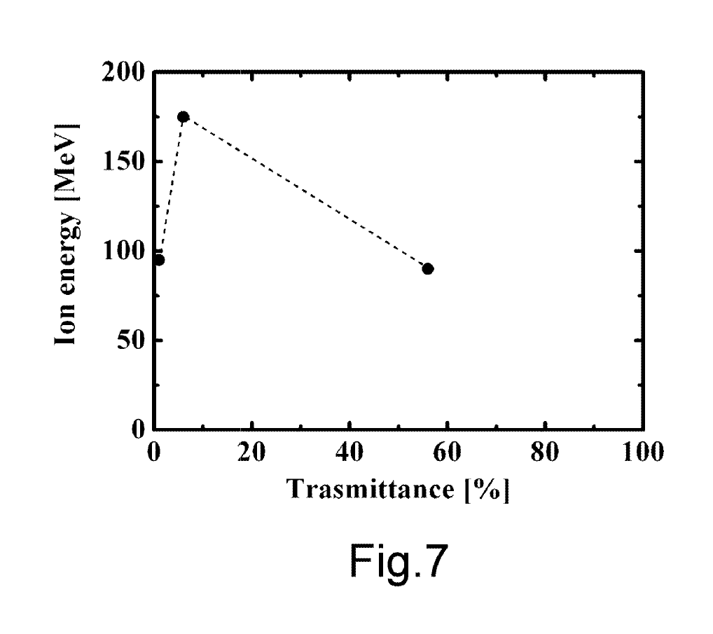

FIG. 7 shows a simulation result on the relationship between the laser light transmittance and the ion energy. It is shown that the transmittance of the laser light 20 of 5% to 10% is advantageous for the generation of high-energy ions, causing a magnetic vortex in the foregoing position of approximately 95%.

The foregoing discussion has dealt with spatial limitations on the irradiation of the laser light 20. Meanwhile, as shown in FIG. 2, the cluster gas 30 is formed with temporal limitations. The timing of generation of the cluster gas 30 [(b) of FIG. 2] therefore needs to be synchronized with the timing of irradiation with the laser light 20 [(c) of FIG. 2].

As shown in FIG. 2, the duration for which the cluster-gas 30 is generated is generally the same as the duration for which the nozzle 40 is ON, approximately 0.01 to 10 ms (for example, 1 ms). If the duration is too short, a sufficient amount of cluster-gas 30 fails to be generated. This makes it difficult to generate an ion beam of sufficient intensity. If the duration is too long, the background vacuum against which the mixed gas is jetted deteriorates. This precludes sufficient adiabatic expansion of the gas, interfering with the formation of CO₂ clusters 32 in the cluster-gas 30. The duration is several orders of magnitude longer than the interval between the pre-pulse and main pulse of the laser light 20, the half-widths of the pre-pulse and the main pulse, the duration of plasma generation, and the time that elapses before the emission of electrons and ions from the cluster gas 30. The irradiation timing may thus be determined arbitrarily as long as He atoms 31 and CO₂ clusters 32 can be formed in the cluster gas 30 as described above.

If the ON duration is long, the vacuum deteriorates depending on such factors as the configuration of the vacuum chamber and the evacuation speed of the vacuum pump in use. It is evident that the background vacuum deteriorates in the late stage of the period when the nozzle 40 is ON. In other words, the stable formation of the cluster-gas 30 would actually take place in the early stage of the period when the nozzle 40 is ON. For example, it is preferred to perform the irradiation of the laser light 20 in the initial 10% to 20% or so of the period between when the nozzle 40 is turned ON and when the nozzle 40 is turned OFF.

While the foregoing example has dealt with the case where D=3.0×10⁹ cm⁻³, the density D may be in the range of 2.0×10⁸ to 2.0×10¹⁰ cm⁻³.

The foregoing configuration has dealt with the case of using a cluster-gas that is made of a mixed gas of He and CO₂ and in which CO₂ clusters are formed. However, a mixed gas of other compositions may be used to form other types of clusters.

The ion acceleration apparatus described above can provide a high-quality ion beam by controlling such factors as the focal position of the laser light (focusing optical system) and the open and close timing of the nozzle that issues a jet of mixed gas. The ion acceleration apparatus can thus be constituted without much change to a conventional laser-driven ion acceleration apparatus. This enables miniaturization of the entire apparatus as compared to acceleration apparatuses of other types, and allows applications to medical use and various other fields.

Ions accelerated by the foregoing ion acceleration apparatus may be used to irradiate samples. Such a configuration can construct an ion beam irradiation apparatus that performs irradiation with various types of ions as an ion beam. Conventional ion beam irradiation apparatuses have been difficult to miniaturize as a whole since their ion-accelerating mechanisms using a cyclotron, a radio frequency cavity, and the like are large in size. In contrast, the ion beam irradiation apparatus can be reduced in overall size since the accelerating mechanism can be miniaturized as described above. The ion beam irradiation apparatus is therefore easy to introduce into various facilities such as medical facilities, and can be particularly suitably used as a medial ion beam irradiation apparatus.

1. An ion acceleration method comprising irradiating a cluster-gas with pulsed laser light in a direction generally perpendicular to a jetting direction of a mixed gas to generate a plasma of the cluster-gas so that an atom constituting the cluster-gas is ionized and accelerated, the cluster-gas being formed by jetting the mixed gas including a first component gas and a second component gas from a nozzle into a vacuum to form from the nozzle a columnar shaped cluster-gas in which clusters of molecules of the second component gas suspend in the first component gas,
the clusters in the cluster-gas having a density in the range of 2.0×10⁸ to 2.0×10¹⁰ cm⁻³,
the pulsed laser light being focused on a position of 80% to 100% rearward of the columnar shaped cluster-gas when seen from an irradiation side.

2. The ion acceleration method according to claim 1, wherein the columnar shaped cluster-gas has a transmittance in the range of 5% to 10% to the pulsed laser light.

3. The ion acceleration method according to claim 1, wherein a duration of jetting of the mixed gas is 0.01 to 10 ms, and the columnar shaped cluster-gas is irradiated with the pulsed laser light in the range of 10% to 20% the duration of jetting since generation of the cluster-gas in terms of generation timing of the cluster-gas that is formed in response to the duration of jetting.

4. The ion acceleration method according to claim 1, wherein the first component gas is He, and the second component gas is CO₂.

5. An ion acceleration apparatus for irradiating a cluster-gas with pulsed laser light to generate a plasma of the cluster-gas so that an atom constituting the cluster-gas is ionized and accelerated, the ion acceleration apparatus comprising:
a nozzle that jets a mixed gas of a first component gas and a second component gas into a vacuum to form a columnar shaped cluster-gas in which clusters of molecules of the second component gas suspend in the first component gas;
a laser light source that oscillates the pulsed laser light; and
a focusing optical system that irradiates the cluster-gas with the pulsed laser light so that the pulsed laser light is focused on a preset focal point,
the clusters in the cluster-gas having a density in the range of 2.0×10⁸ to 2.0×10¹⁰ cm⁻³,
the focal point being located in a position of 80% to 100% rearward of the columnar shaped cluster-gas from an irradiation side.

6. The ion acceleration apparatus according to claim 5, wherein the columnar shaped cluster-gas has a transmittance in the range of 5% to 10% to the pulsed laser light.

7. The ion acceleration apparatus according to claim 5, wherein a duration of jetting of the mixed gas is 0.01 to 10 ms, and the columnar shaped cluster-gas is irradiated with the pulsed laser light in the range of 10% to 20% the duration of jetting since generation of the cluster-gas in terms of generation timing of the cluster-gas that is formed in response to the duration of jetting.

8. The ion acceleration apparatus according to claim 5, wherein the first component gas is He, and the second component gas is CO₂.

9. An ion beam irradiation apparatus comprising a configuration that irradiates a sample with an ion accelerated by an ion acceleration apparatus for irradiating a cluster-gas with pulsed laser light to generate a plasma of the cluster-gas so that an atom constituting the cluster-gas is ionized and accelerated, the ion acceleration apparatus comprising:
a nozzle that jets a mixed gas of a first component gas and a second component gas into a vacuum to form a columnar shaped cluster-gas in which clusters of molecules of the second component gas suspend in the first component gas;
a laser light source that oscillates the pulsed laser light; and
a focusing optical system that irradiates the cluster-gas with the pulsed laser light so that the pulsed laser light is focused on a preset focal point,
the clusters in the cluster-gas having a density in the range of 2.0×10⁸ to 2.0×10¹⁰ cm⁻³,
the focal point being located in a position of 80% to 100% rearward of the columnar shaped cluster-gas from an irradiation side.

10. An ion beam irradiation apparatus for medical use comprising a configuration that irradiates an affected area with an ion accelerated by an ion acceleration apparatus for irradiating a cluster-gas with pulsed laser light to generate a plasma of the cluster-gas so that an atom constituting the cluster-gas is ionized and accelerated, the ion acceleration apparatus comprising:
a nozzle that jets a mixed gas of a first component gas and a second component gas into a vacuum to form a columnar shaped cluster-gas in which clusters of molecules of the second component gas suspend in the first component gas;
a laser light source that oscillates the pulsed laser light; and
a focusing optical system that irradiates the cluster-gas with the pulsed laser light so that the pulsed laser light is focused on a preset focal point,
the clusters in the cluster-gas having a density in the range of 2.0×10⁸ to 2.0×10¹⁰ cm⁻³,
the focal point being located in a position of 80% to 100% rearward of the columnar shaped cluster-gas from an irradiation side.
